(19) United States
(12) Patent Application Publication
(10) Pub. No.: US 2010/0046862 A1
(43) Pub. Date: Feb. 25, 2010

(54) LINEAR COMPRESSOR AND GAS THRUST BEARING THEREFOR

(75) Inventor: Jan-Grigor Schubert, Senden (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, München (DE)

(21) Appl. No.: 12/513,711

(22) PCT Filed: Oct. 30, 2007
(86) PCT No.: PCT/EP2007/061663

§ 371 Date: May 6, 2009

(30) Foreign Application Priority Data
Nov. 7, 2006 (DE) 10 2006 052 447.0

(51) Int. Cl. F16C 32/06

(52) U.S. Cl. 384/12

(57) ABSTRACT

A gas thrust bearing includes a cavity, a body moveable in the cavity, and a bearing bush surrounding the cavity and the moveable body. The bearing bush includes a wall defining an inner chamber, and a plurality of supply holes in the wall and configured such that compressed gas applied on an outer side of the bearing bush forms a gas cushion in the inner chamber to support the movable body. The body includes a material having a coefficient of thermal expansion that is different than a coefficient of thermal expansion of a material of the bearing bush.

The present invention relates to a gas thrust bearing and a linear compressor in which the gas thrust bearing is able to be used.

Conventionally a gas thrust bearing comprises a bearing bush surrounding a cavity in which a body is supported to allow movement with little play, with a plurality of supply holes to which compressed gas can be applied on the outer side of the bearing bush passing through the bearing bush. Gas flowing through the supply holes into the cavity forms a gas pillow between the inner wall of the bush and the mobile body, through which the body is held in a non-contact manner in the cavity. The body is able to perform a rotational movement in the bearing bush or be displaced in an axial direction.

Keeping the body supported without it touching the bearing bush demands a continuous supply of compressed gas. If however a device in which the gas thrust bearing is used is out of operation it is generally desirable to be able to interrupt the supply of compressed gas, so that no unnecessary operating costs arise. If the device generates the compressed gas itself, switching off the device inevitably leads to an interruption of the compressed gas supply. If the compressed gas supply is switched off or insufficient however, friction contact occurs between the movable body and the bearing bush and thereby wear occurs when the body is moved. To minimize wear in such a situation it is desirable to be able to set up a functioning gas cushion with the least possible delay after the movement starts.

A gas thrust bearing of the type described above acts as a gas spring, whereby with the same pressure of the supplied compressed gas the force which the bearing can accept without any contact between the movable body and the bearing bus occurring, with small gap widths of the order of a few micrometers to a few tens of micrometers increases with the width of the gap. Conversely this means that, with a large width of the gap between bearing bush and movable body, a lower pressure of the fed compressed gas is already sufficient for the gas cushion to carry the weight of the movable body and prevent contact between the body and the bearing bush. This would suggest making the play between bearing bush and body large in order to minimize the time delay with which the gas thrust bearing produces its effect after the compressed gas supply is started. However a large gap between the bearing bush and the body also demands the outflow of the gas forming the cushion from the gap, meaning that, to maintain the bearing effect, the gas throughput requires increases with the gap width, which in its turn leads to increased operating costs.

The object of the present invention is thus to specify a gas thrust bearing, that on the one hand is already able to establish an effective gas cushion when the pressure of the supplied gas is low and that on the other hand allows long-term operation with low gas throughput.

This object is achieved for a gas thrust bearing of the type mentioned at the start by making the body and the bearing bush from materials with different coefficients of thermal expansion. Whereas for a typical non-operating temperature of the gas thrust bearing there can be a large gap width between bearing shell and movable body, that even with a low gas pressure makes it possible to hold the body without contact, controlling the temperature of the gas thrust bearing during operation enables the gap to be narrowed to allow operation with low gas throughput.

To control the column width in this manner, a device for tempering the bearing bush and/or the movable body as a component of the gas thrust bearing is provided.

Such a device for tempering can take a wide variety of forms; for example the bearing bush can be provided with an electrical resistive heater or means for inducing eddy currents in the movable body, if necessary by utilizing its movement, can be provided.

An advantageous indirect option of tempering is to provide a device for tempering the compressed gas supplied to the supply holes.

In accordance with a preferred embodiment the device for tempering is a compressor which causes an adiabatic heating up of the compressed gas in the compressor.

In particular the cavity of the bearing bush can be an operating chamber and the movable body a piston of this compressor.

The gas throughput of the compressor can be multiple of the throughput of the supply holes; i.e. only a small part of the compressed gas is needed to maintain the gas cushion, while the major part of the remainder is available for other applications.

If the temperature of the gas thrust bearing is higher during operation than in the non-operational state, the piston, in order to narrow the gap during operation, should have a higher coefficient of thermal expansion than the bearing bush.

Thus the movable body can especially be made of stainless steel and the bearing bush or tool steel.

Further features and advantages of the invention emerge from the description of exemplary embodiments given below, which refers to the enclosed figures. The figures are as follows:

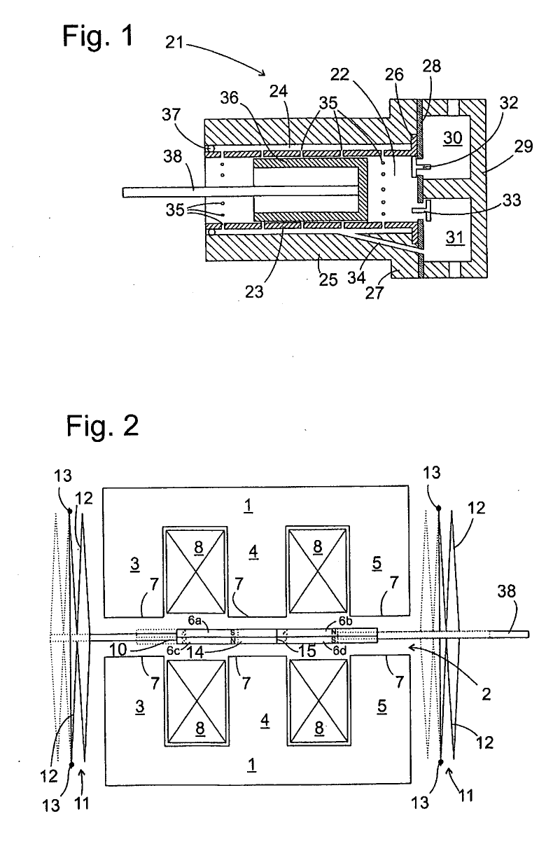

FIG. 1 a schematic section through a compressor with gas thrust bearing in accordance with the present invention; and

FIG. 2 a schematic diagram of a drive unit for the compressor.

The compressor shown in FIG. 1 has a housing 21 with a hollow-cylindrical bearing bush 23 delimiting a working chamber 22. The bearing bush 23 is surrounded by a cavity 24 and this cavity in its turn is delimited by an essentially tubular-shaped housing part 25. The bearing bush 23 and the housing part 25 each have an annular flange 26 or 27 running around them at one end, with the flange 26 of the bearing bush 23 engaging in a cutout delimited on one side by the housing part 25 and on the other side by a spring plate 28, with the bearing bush 23 being fixed to the housing part 25 and the spring plate 28 and the flange 27 of the housing part 25 being rigidly connected in any suitable manner and forming a hermetic seal to the spring plate 28. At an end facing away from the flange 27, 28 the cavity 24 is sealed by an O-ring 37 clamped between bearing bush 23 and housing part 25.

A cap 29 attached to the side of the spring plate 28 opposite the housing part 25 delimits two chambers 30, 31, which communicate with the working chamber 22 via the valves 32, 33 depicted in the figure and preferably formed in one piece from the spring plate 28. The valves 32, 33 are check valves which respectively only allow a flow of gas from their upper, suction-side chamber 30 into the working chamber 22 or from the working chamber 22 into the lower, pressure-side chamber 31. A hole 34 connects the pressure-side chamber 31 with the cavity 24 surrounding the bearing bush 23.

Via a plurality of holes 35 extending through the bearing bush 23 compressed gas can get into the working chamber 22 from the cavity 24 and can form a gas cushion there between the inner side of the bearing bush 23 and a piston 36 able to be displaced in the bearing bush 23. The piston 36 is able to be driven with the drive device shown in FIG. 2 via a connecting rod 38 and is able to be driven to produce an oscillating movement.

The piston 36 is made from stainless steel. A typical coefficient of thermal expansion of a stainless steel is 16×10⁻⁶ K⁻¹. The bearing bush 23 on the other hand is made of tool steel and has a coefficient of thermal expansion of 13×10⁻⁶ K⁻¹. Naturally other combinations of materials for the piston 36 and the bearing bush 23 can be considered, provided the material of the piston has a higher coefficient of thermal expansion than the relevant bearing bush. Parts of the piston 36 and the bearing bush 23 can also be made of materials which do not fulfill the above condition, provided this does not significantly change the difference between the global coefficient of thermal expansion of the two parts; In particular the two parts can be provided with hardening and/or friction-reducing surface coatings.

According to a preferred application the compressor shown in FIG. 1 can be used for compressing coolant in a domestic refrigerator. In this case the compressor is essentially at room temperature in a non-operational state. The external diameter of the piston 36 and the internal diameter of the bearing bush 23 amount to appr. 30 millimeters, with the diameter of the piston at room temperature being made appr. 14 micrometers smaller than that of the bush 23, so that, if the piston 36 is exactly centered, a surrounding gap of 7 micrometers wide separates it from the bearing bush 23.

If the compressor is put into operation and the drive unit begins to move the piston 36, there is initially no difference in pressure between the working chamber 22 and the cavity 24. No gas cushion is created and the piston 36 moves in contact with the bearing bush 23. Only through the oscillating movement of the piston 36 is a feed pressure produced in the chamber 31, and a part of the gaseous coolant compressed in the working chamber 22 and expelled into the pressure-side chamber 31 flows back into the cavity 24 and is applied there to the holes 35. As soon as a sufficient overpressure is created in the cavity 24, the gas cushion becomes effective and prevents a further friction between the piston 36 and the bearing bush 23.

The compression in the working chamber 22 causes the compressed coolant to heat up, and the flowing back of the warm coolant into the cavity 24 also causes the bearing bush 23 and the piston 36 to heat up during operation. The heating up can typically amount to appr. 50 K. Such heating up reduces the width of the gap between the piston 36 and the bearing bush 23 from 7 micrometers when the compressor is started to appr. 4.75 micrometers during continuous operation. As a result of the narrowing of the gap the gas throughput through the holes 35 is significantly reduced in the warm state in relation to the startup phase.

In the startup phase the compressor also has a relatively low efficiency, because a relatively large part of the coolant is diverted to maintain the gas cushion. At the same time however a relatively low feed pressure of the coolant is sufficient in the start phase to keep the piston 36 from coming into contact with the bearing bush 23. In continuous operation there is sufficient pressure of the compressed coolant available to also guarantee no contact even with a reduced gap width. The fact that the gap width is reduced by the heating up means that in this situation the quantity of coolant necessary to maintain the gas cushion can be reduced, which increases the efficiency of the compressor.

FIG. 2 shows a schematic diagram of the drive unit which drives the oscillating movement of the piston 36. It comprises two E-shaped yokes 1 with three opposing pairs of arms 3, 4, 5. The ends of the arms 3, 4, 5 facing towards each other each form a pole shoe 7 delimiting an air gap 2. An excitation winding 8 is attached around the central arm 4 in each case. The two excitation windings 8 are able to be supplied with current by a control circuit, with the current direction in the two excitation windings 8 being defined in each case so that the opposing pole shoes 7 of the center arms 4 form magnetic poles of dissimilar polarity. The pole shoes of the outer arms 3 and 5 each form magnetic poles of dissimilar polarities in relation to the adjacent center arm 4.

In the air gap 2 an armature 10 is suspended between two springs 11 between an upper and a lower inversion point (or respectively a right-hand and a left-hand inversion point in the diagram depicted in FIG. 2) so that its movement can be reversed. The position of the armature 10 at the upper inversion point is shown by solid lines, the position at the lower inversion point by dashed lines. The springs 11 are leaf springs punched from a sheet of metal in each case with a number of arms 12 running in a zigzag. The arms 12 of one spring 11 extend respectively as a mirror image of one another from a central attachment point at the armature 10 to suspension points 13 on a rigid frame not shown, to which the yoke 1 and the compressor are also anchored. This embodiment makes the springs 11 difficult to deform in the longitudinal direction of the armature 10 and in each direction orthogonal thereto, so that they guide the armature 10 in its longitudinal direction reversibly.

The essentially rod-shaped armature 10 has a four-pole permanent magnetic core 14 in its central area. Whereas in a relaxed position of the springs 11, in which the arms 12 of each spring 11 lie essentially in the same plane, the magnet 14 is placed centrally in the air gap 2 and a boundary line 15 between its left-hand and right-hand poles shown in FIG. 1 runs centrally through the central arms 4, supplying the windings 8 with a current moves the armature 10 to the left or to the right depending on the direction of the current.

The exemplary embodiment explained above uses the adiabatic heating up of the coolant associated with compressor operation to heat up the piston 36 in operation. Naturally a change in temperature altering the gap width between piston and bearing bush between an operational and a non-operational state can also be effected by direct heating (or cooling) of the piston and the bearing bush.

1-8. (canceled)

9. A gas thrust bearing comprising:
a cavity;
a body moveable in the cavity; and
a bearing bush surrounding the cavity and the moveable body,
wherein the bearing bush includes:
a wall defining an inner chamber; and
a plurality of supply holes in the wall and configured such that compressed gas applied on an outer side of the bearing bush forms a gas cushion in the inner chamber to support the movable body,
wherein the body includes a material having a coefficient of thermal expansion that is different than a coefficient of thermal expansion of a material of the bearing bush.

10. The gas thrust bearing as claimed in claim 9, comprising:
a device for tempering one of the bearing bush and the movable body.

11. The gas thrust bearing as claimed in claim 9, comprising:
a device for tempering the compressed gas applied to the plurality of supply holes.

12. The gas thrust bearing as claimed in claim 10, wherein the device for tempering is a compressor.

13. The gas thrust bearing as claimed in claim 11, wherein the device for tempering is a compressor.

14. The gas thrust bearing as claimed in claim 9, comprising:
a device for one of tempering the bearing bush and the movable body, and tempering the compressed gas applied to the plurality of supply holes,
wherein the device for tempering is a compressor, and
wherein the cavity is a working chamber of the compressor and the movable body is a piston of the compressor.

15. The gas thrust bearing as claimed in claim 14, wherein the compressor has a gas throughput that is multiple times a gas throughput of the plurality of supply holes.

16. The gas thrust bearing as claimed in claim 14, wherein the compressor has a gas throughput that is greater than a gas throughput of the plurality of supply holes.

17. The gas thrust bearing as claimed in claim 9, wherein a coefficient of thermal expansion of the piston is greater than a coefficient of thermal expansion of the bearing bush.

18. The gas thrust bearing as claimed in claim 15, wherein the movable body includes stainless steel and the bearing bush includes tool steel.

19. The gas thrust bearing as claimed in claim 15, wherein one of the movable body and the bearing bush includes one of a hardening surface coating and a friction-reducing surface coating.
